(19) United States
(12) Patent Application Publication
(10) Pub. No.: US 2012/0246330 A1
(43) Pub. Date: Sep. 27, 2012

(54) Code access via the web to multiple databases

(76) Inventor: L. Joseph Marhoefer, Reston, VA (US)

(21) Appl. No.: 13/506,870

(22) Filed: May 22, 2012

Related U.S. Application Data
(63) Continuation-in-part of application No. 12/925,152, filed on Oct. 15, 2010.
(60) Provisional application No. 61/403,797, filed on Sep. 22, 2010.
(60) Provisional application No. 61/631,703, filed on Jan. 10, 2012.

(51) Int. Cl. G06F 15/16

(52) U.S. Cl. 709/228; 709/245

(57) ABSTRACT

A web-hosted system includes a server and a block of memory addresses accessed via an URL application on a mobile device. Within the block of memory addresses there are several independently addressable and independently managed sub-blocks. Short codes inputted by a user on his or her mobile device address both the sub-block and data within the sub-block.

### CROSS REFERENCE TO RELATED APPLICATIONS

This application is a continuation in part of U.S. patent application Ser. No. 12/925,152 filed Oct. 15, 2010 entitled “System to Improve Response to Radio Advertising”, which claims priority of provisional application Ser. 61/403,797 filed Sep. 22, 2010 both of which are incorporated herein by reference and also claims priority of provisional application Ser. No. 61/631,703 filed Jan. 10, 2012 in corporate herein by reference.

### FIELD OF THE INVENTION

This invention relates to accessing a database via the web with a code input, and more particularly to using a short code to address data in a selected one of several independently managed databases that have the same URL web address.

### BACKGROUND OF THE INVENTION

Patent application Ser. No. 12/925,152 refereed to above, describes a system and method that uses a reusable short code to address a database where additional information (for example, telephone number and email address) is stored. A person seeing or hearing an advertisement with the short code enters the code on his or her mobile device via a keyed entry or voice entry, and gets back the advertiser's information stored at the address. The system of the '152 application is similar in application to the optical code systems such as those using so called QR codes in connection with their ads. But the short alphanumeric codes of the '152 application are usable where the optical scan codes cannot be used such as in radio broadcast, and where the optical codes are not practical, such as road side bill board ad. The following is a brief summary of some prior art technology as it applies to mobile communications devices, particularly so-called smart phones and tablet devices.

“URL shorting” is a technique that shortens a URL while still directing to the requested page. This entails using an HTTP redirect from a URL that is short. The redirect links to the web page that has the longer URL. It often used in twitter and identi.ca, which restrict the number of characters in a message including the address characters.

“Short codes” (short numbers) are special telephone numbers that are significantly shorter than regular telephone numbers. These short codes can be used as the address to send SMS (short message service) and MMS messages from the mobile phones or fixed phones of certain service providers. There are two types of short codes, dialing and messaging. Short codes are used for value added services such as TV program voting, charity donations, and the like. Messages sent via short code can be billed at a rate higher than the standard MMS.

“StarStar Numbers™” are “intelligent” phone numbers comprised of a 1 to 15 character string of letters or numbers preceded by the character *. A StarStar number that is attractive to an advertiser (e.g. GM for General Motors) can be “leased” by the advertiser. StatStar numbers are intended to help advertisers reach mobile phone users. A * star number can be called just like any regular telephone number. There is no need to down load and call up an application in making the call. The call can be presented with any one of a variety of responses designated by the advertiser, such as voice, text message, video, mobile coupon, application, extra. The Zoov Corp. operates the StarStar number registry and content delivery platform in the U.S. leasing the StarStar numbers to advertisers.

### SUMMARY OF THE INVENTION

An object of this invention is the provision of a short code system that addresses via the web data in one of several independently managed memory blocks that have the same URL web address.

Briefly this invention contemplates the provision of web-hosted system accessed via a URL address. The system includes a server and a block of memory addresses accessed by the URL address. Within this block of addresses there are several independently addressable and independently managed sub-blocks of addresses. Collectively the block of address and the sub-block are sometimes referred to here in a database. Short codes, which can be as short as two characters, address both a particular sub-block and also address particular data stored at the sub-block. An application residing on a mobile device, such as a smart phone, or tablet computer connects the mobile device to the web-hosted system at the URL address. The user then inputs the code. The code encodes two addresses. The address of a particular sub-block of addresses and the address of particular data stored at that sub-block. For example, consider a code consisting of two alpha characters such as “aa”, “ab” . . . “ba”, “bb”, . . . and so on. The first character can be the address of one of the independently addressable sub-blocks and the second character can be the address particular data stored at the sub-block address. In this example, there can be up to twenty-six sub-blocks each with twenty-26 addressable locations. Each sub-block has a manager program that allows data to be added and deleted from the sub-block, keeps records, and communicates with a data terminal for a particular sub-block. A data terminal can be coupled to a sub-block manager through a URL specific to that sub-block and/or a pin so that each sub-block or group of sub-blocks is independently managed.

### BRIEF DESCRIPTION OF THE DRAWINGS

FIG. 1 is a block diagram of web-based, server controlled, database, which has, in accordance with the teachings of this invention, several independently addressed and independently managed data storage sites address by a short reusable code.

FIG. 2 is a drawing that illustrates an example of the short reusable alphanumeric codes that are used to address a specific site in the database and specific data at that site.

FIG. 3 is a drawing that illustrates on example of an organization of a database in accordance with the teachings of the invention.

FIG. 4 is an illustration of the use of a QC tag in combination with a QR code.

### DETAILED DESCRIPTION OF THE INVENTION

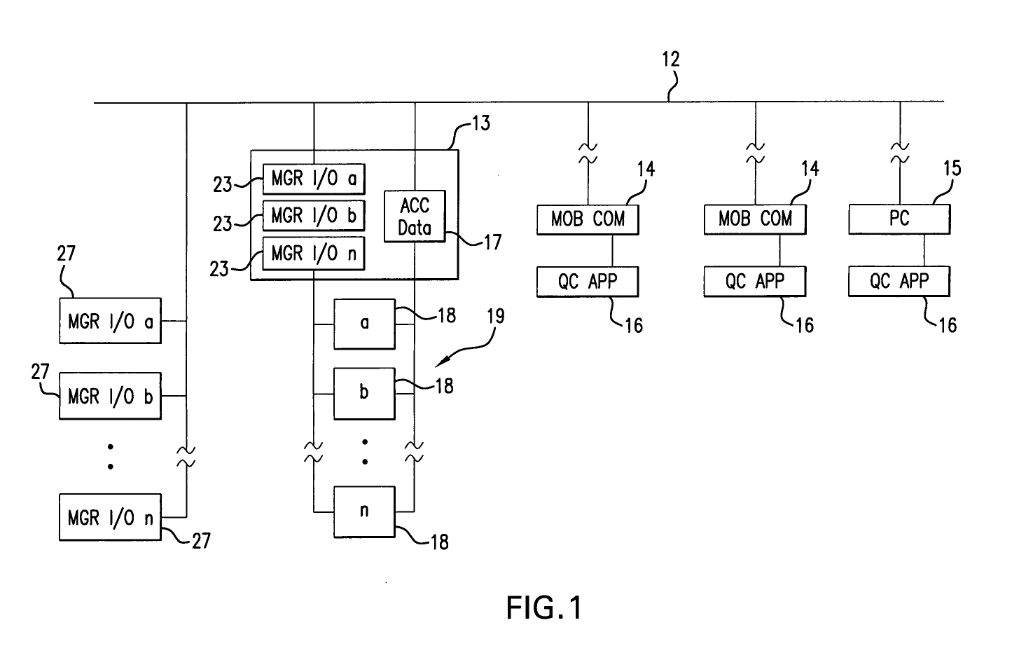

Referring now to FIG. 1, the line 12 indicates a web connection between and among the various hardware and software components. While not limited thereto, implementation of the invention in the so-called “cloud”-computing environment is envisioned. A server 13 is accessed via a wireless mobile communications device 14 such as a smart phone or other mobile personal communications device such as a tablet computer. The server 13 can also be accessed from a computer 15 such as a pc coupled to the web via hard-wired connection. Each mobile device 14 and each pc 15 stores an application program 16 (QC app) that, when activated by the user, connects the device 14 or 15 to the server 13 at a URL address specified by the application program 16. At this URL address the server 13 provides a memory address decoder and data access software 17 to access data stored in at any one of a plurality of address locations 18 referred collectively herein as database 19.

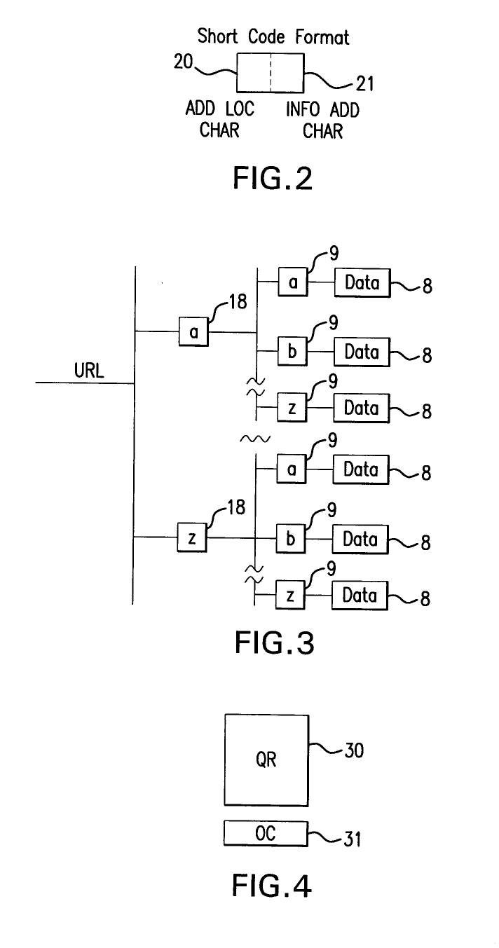

Referring now to FIG. 2 in addition to FIG. 1, FIG. 2 illustrates one example of the code format that allows a user to address data in any one of the of the address locations 18 numbered a, b, . . . n from his or her device 14 or 15. The code format allows for short easy to remember codes such as alpha-alpha, alpha-numeric, or alpha-alpha-alpha etc. In this one example, the first letter 20 of the code is the address of one of the independently addressable locations 18. The remaining characters 21 of the code address a specific location in that location 18. For example, a code input “a e” addresses the address location “a” and accesses the data stored in address location “a” at address “e”. The data stored at e is, for example, the phone number of an advertiser. The phone number fetched by the server and sent via the web to the person's device 14 or 15 that initiated the request, where he or she may make the call right away by touching the screen where the number is displayed, or save number and make the call later. With a three-character code in the format alpha-alpha-alpha, for example, 26 databases can be addressed with each database having 625 addressable entries. Similarly, using the first two characters as the address of the database, 625 databases can be address each with 25 addressable entries. Of course, numbers can be used alone or in combination with letters, for example, 438, and C10, and capitals, the # sign, the * sign can be used to extent the number of short codes.

A simple example of the invention is illustrated in FIG. 3 for a short alphanumeric code limited to two alpha characters. With this two alpha code, the database can be organized as twenty-six independently addressable blocks 18, with addresses a through z, only two of which are illustrated in FIGS. 1, 18a and 18z. Each of these blocks can store data 8 at each of number of address locations 9 within the block. Again, as illustrated in FIG. 3, there are twenty-six addresses a through z in each block. Data stored at an address within the block would typically include an advertisers' message; such as an advertiser's phone number, email address, and/or video.

The server 13 includes a separate instance of data management software 23 labeled MGR a, MGR b, . . . MSGR n, that allows each of the independently addressable address locations 18 to be managed independently via an assigned I/O terminal 27, correspondently lettered a through n. Each input/output device 27, such as a computer terminal, allows a person to add and delete data respectively from a block to which it is assigned. It should be noted that in a preferred embodiment of the invention, the data management software in combination with the I/O device 27 software allows access by the only to the address location 18 to which the I/O device 27 is assigned. For example, a respectively different URL and/or pin sent by the I/O device 27, which is used by the data management software 23 to address a sub-block from its assigned I/O device 27.

In the embodiment of FIG. 1, it contemplates the use of a commercially available smart mobile phone such as Apple's iPhone or similar smart mobile phone. The mobile phone will be loaded with the application that connects the phone to the server via the web using the server's URL. When activated by the user, the downloaded application connects the phone to the server via the server's URL. As explained above, when the user then enters the short code, called here a Quick Connect tag or QC tag, it addresses a specific database and an address in the database. Also presently available are smart mobile with voice recognition capabilities such as Apple's iPhone 4. Here, the user calls up the Quick Connect application, either with a touch screen icon or a voice command, and enters the Quick Connect tag via voice command, which is translated by the phone to a corresponding digital address sent to the server. The advantage here is that with a limited vocabulary the voice instructions are most likely to be correctly interpreted by the phone's voice recognition software.

While the short alpha and alphanumeric code contemplated by this invention has clear use in audio applications, such as radio broadcast, it also clearly has use where there is a visual image of the short code, such as billboard advertising, newspaper, magazine, and TV advertising, and can be used advantageously in combination with the optical QR code. For example, FIG. 4 illustrates a printed QR code 30 with a printed QC tag 31 beneath it. This provides the mobile device user with a choice. Often it will be more convenient to enter the QC tag than to take a picture of the QR code.

U.S. patent application Ser. No. 12/925,152 filed Oct. 15, 2010 entitled System to Improve Response to Radio Advertising, referred to above, discloses the reuse of codes based on the geographic area in which the code is used. In that application, the coverage area of a radio broadcast station defines the geographic area. Geographic areas in which code reuse can also be established based on the GPS position of mobile device user. The Quick Connect application can include a program that includes the GPS signal that locates the mobile device position. In a simple example, the U.S. west coast states could be one geographic area and the east cost states another. This GPS signal can be converted to an additional address directed to an east cost or west cost address location 18 that have the same Quick Connect alphanumeric address.

The subject matter that is regarded as the invention is particularly pointed out and distinctly claimed in the claims at the conclusion of the specification.

1. A system to address a plurality of independently addressable address locations via the web, comprising in combination:
a server connected to the web, said server addressable over the web with a single URL from a plurality of mobile devices;
said plurality of independently addressable address locations coupled to said server;
each of said independently addressable address locations addressable with a code where at least one character of the code is the address of one of the address locations, and at least one other character of the code is the address of data in that address location;

2. A method to address a plurality of independently addressable address locations via the web including the steps of:
connecting a server to the web, said server addressable over the web with a single URL from a plurality of mobile devices;
connecting a plurality of independently addressable address locations to said server; and
addressing each of said independently addressable address locations with a short code where at least one character of the code is the address of one of the address locations, and at least one other character of the code is the address of data at that address location.

3. A system to address a plurality of independently addressable address locations via the web as in claim 1 further including an independent database manager for each of said independently addressable address locations.

4. A method to address a plurality of independently addressable address locations via the web as in claim 2 including changing data in said in the in dependently addressable address locations via an independent database manager.

5. A system to address a plurality of independently addressable address locations via the web as in claim 1 wherein a user uses voice commands to enter said short code.

6. A method to address a plurality of independently addressable address locations via the web as in claim 2 wherein a user uses voice commands to enter said short code.
